(19) United States
(12) Patent Application Publication
(10) Pub. No.: US 2012/0055083 A1
(43) Pub. Date: Mar. 8, 2012

(54) Framework For Horizontally Supporting Plants

(76) Inventors: Jose G. Marquez, Hood River, OR (US); Sonja J. Carey, Hood River, OR (US)

(21) Appl. No.: 12/875,360

(22) Filed: Sep. 3, 2010

(51) Int. Cl. A01G 9/12

(52) U.S. Cl. 47/45

(57) ABSTRACT

A framework to horizontally support plants for exposing a greater surface area of the plant to required nutrients, such as sunlight. The framework includes a vertical structure having a lower end and an upper end, the lower end being inserted within the ground adjacent a plant, the upper end adapted to extend above the ground, and a horizontal structure that horizontally extends from the upper end of the vertical structure. The horizontal structure generally comprises a plurality of hollow-shaped supports horizontally spaced from each other and connected via connecting supports, all of which are generally comprised of a wire structure and all of which are substantially located within a common horizontal plane. The plant generally grows through the innermost hollow support and a plurality of fasteners that may extend from the horizontal structure retain an end portion of the plant in a horizontal orientation along the horizontal structure.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a plant support and more specifically it relates to a framework for horizontally supporting plants for efficiently exposing a greater surface area of the plant to required nutrients (e.g. sunlight).

2. Description of the Related Art

Any discussion of the related art throughout the specification should in no way be considered as an admission that such related art is widely known or forms part of common general knowledge in the field.

Plant cages and supporting framework have been in use for years. Typically, plant cages comprise a series of vertically stacked rings in which the plant is supported therein. The plant grows along the interior of the rings and eventually fills the space between each of the rings. As the plant matures, the lower and middle part of the plant can become overly compacted within the rings and hidden by the portion of the plant near the perimeter of the cage and upper part of the cage, which can cause the lower and middle part of the plant to be deprived of adequate sunlight and/or water which can cause uneven growing and/or damage to the plant. Because of the inherent problems with the related art, there is a need for a new and improved framework for horizontally supporting plants for efficiently exposing a greater surface area of the plant to required nutrients (e.g. sunlight).

### BRIEF SUMMARY OF THE INVENTION

A system for efficiently exposing a greater surface area of the plant to sunlight. The invention generally relates to a plant support which includes a vertical structure having a lower end and an upper end, the lower end being inserted within the ground adjacent a plant, the upper end adapted to extend above the ground, and a horizontal structure that horizontally extends from the upper end of the vertical structure. The horizontal structure generally comprises a plurality of hollow-shaped supports horizontally spaced from each other and connected via connecting supports, all of which are generally comprised of a wire structure and all of which are substantially located within a common horizontal plane. The plant generally grows through the innermost hollow support and a plurality of fasteners that may extend from the horizontal structure retain an end portion of the plant in a horizontal orientation along the horizontal structure.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with the horizontal structure being in an alternate embodiment.

FIG. 3 is an upper perspective view of the present invention aligned with a plant.

FIG. 4 is an upper perspective view of the present invention inserted within ground soil and the plant extending through the central opening of the first inner support and retained horizontally along the second and third outer supports.

FIG. 5 is an upper perspective view of the present invention inserted within ground soil and the plant extending through the central opening of the first inner support and retained horizontally along the second and third outer supports, showing the plant being intertwined around the second support for retaining of the plant.

FIG. 6 is a top view of the present invention.

FIG. 7 is a side view of the present invention.

### DETAILED DESCRIPTION OF THE INVENTION

### A. Overview

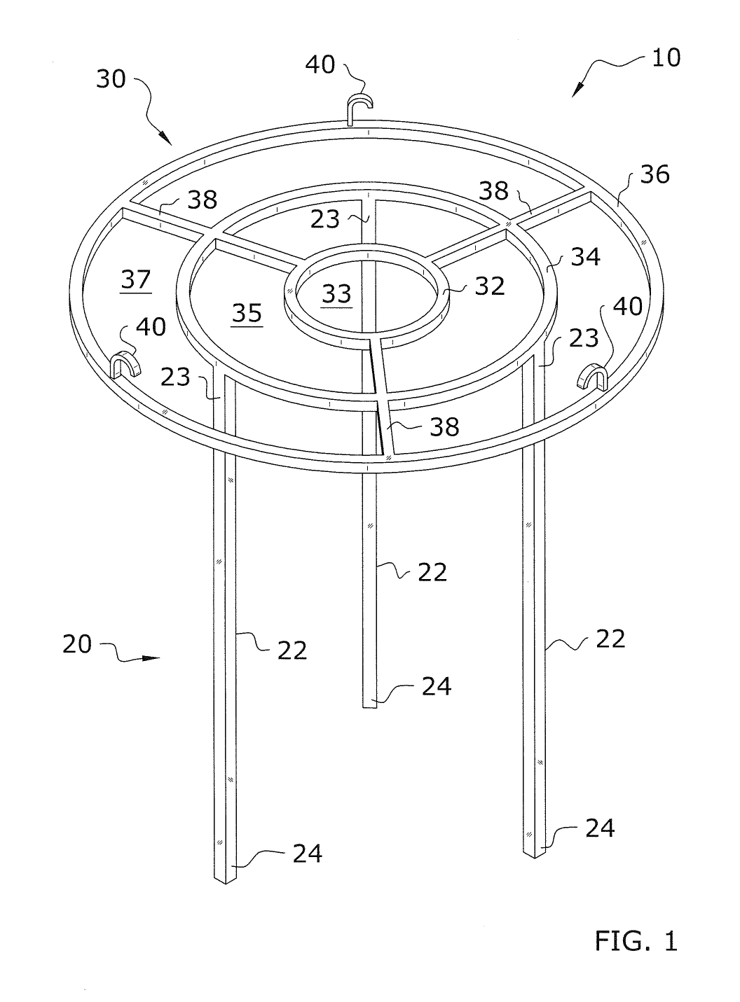

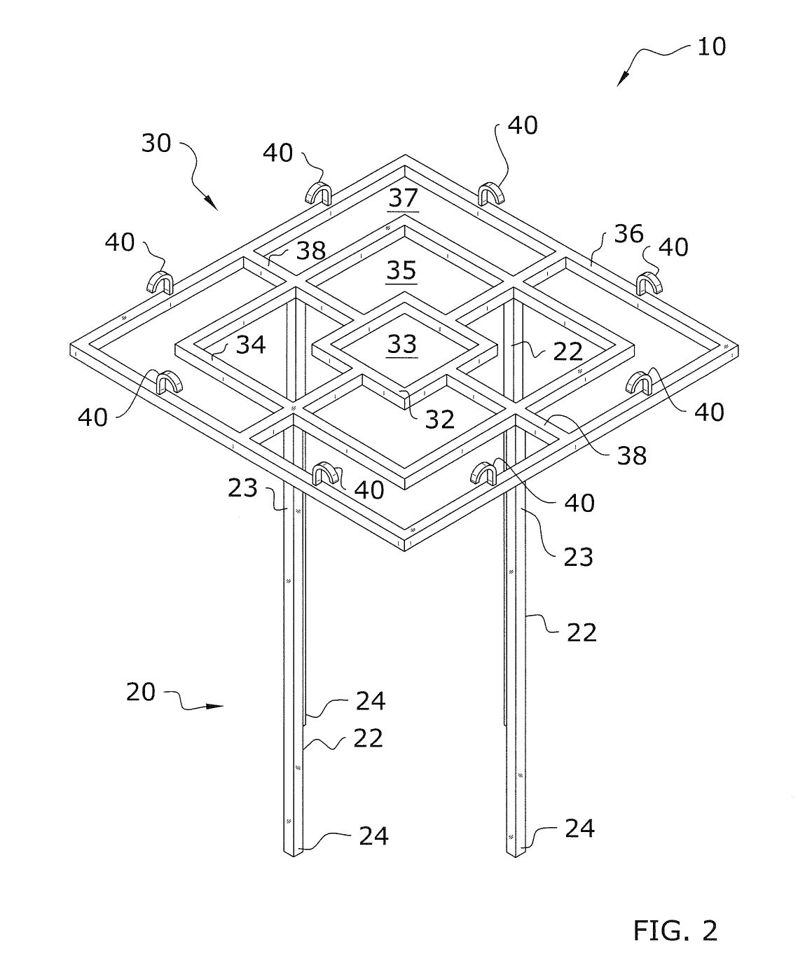

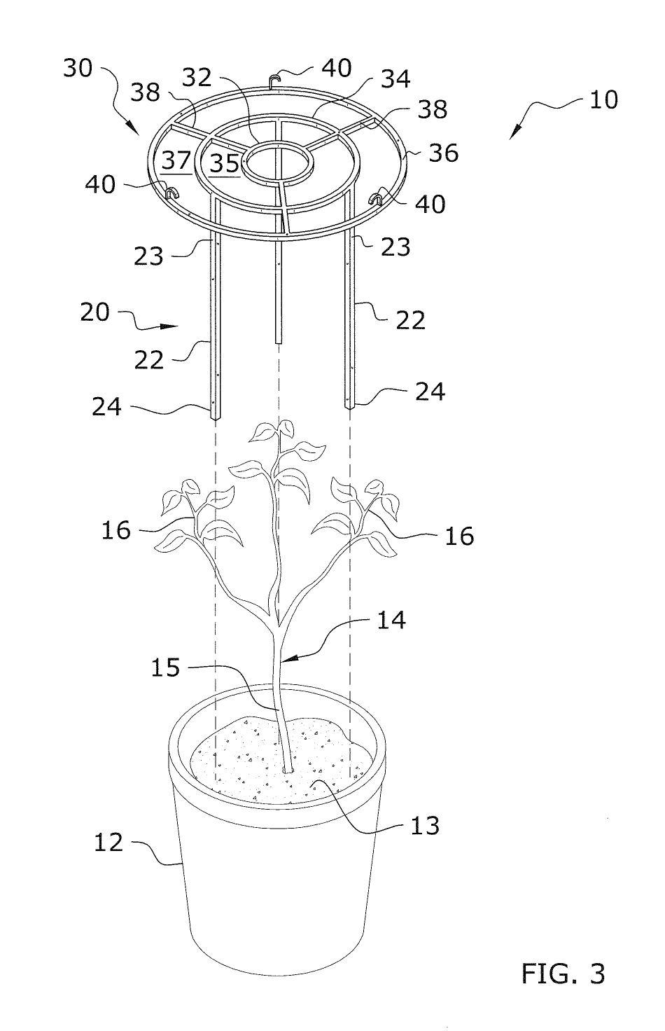

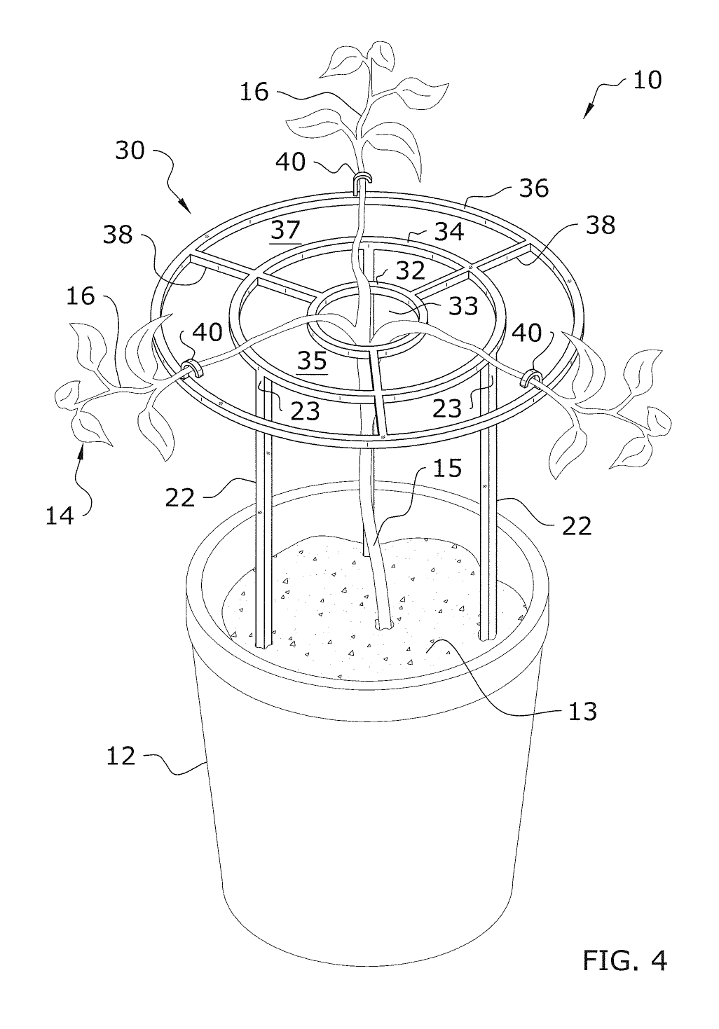

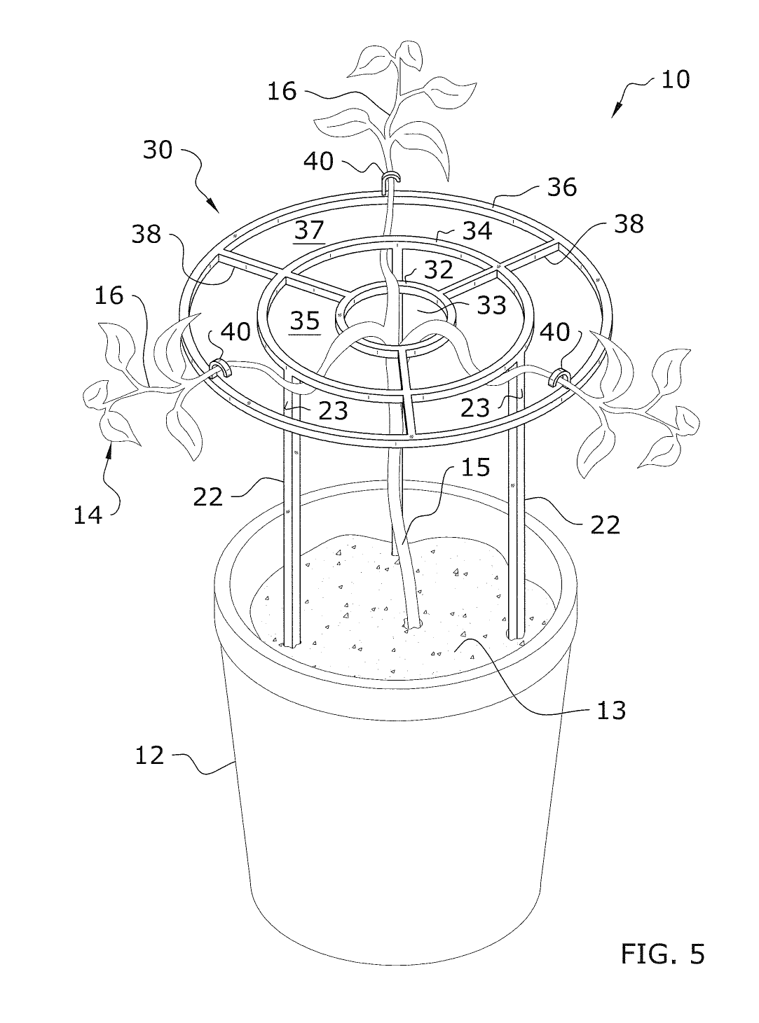

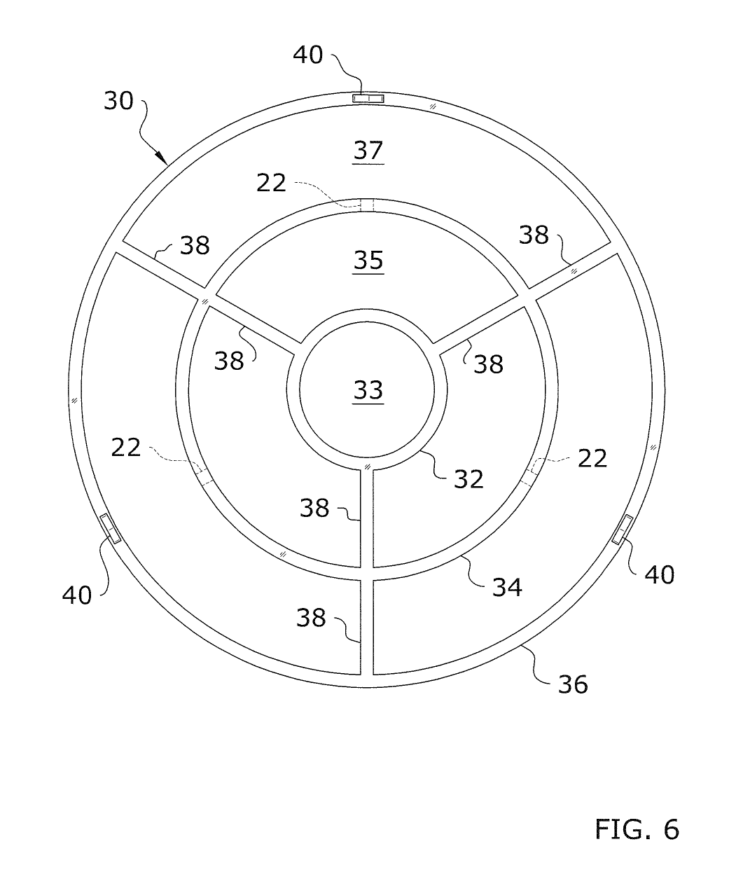

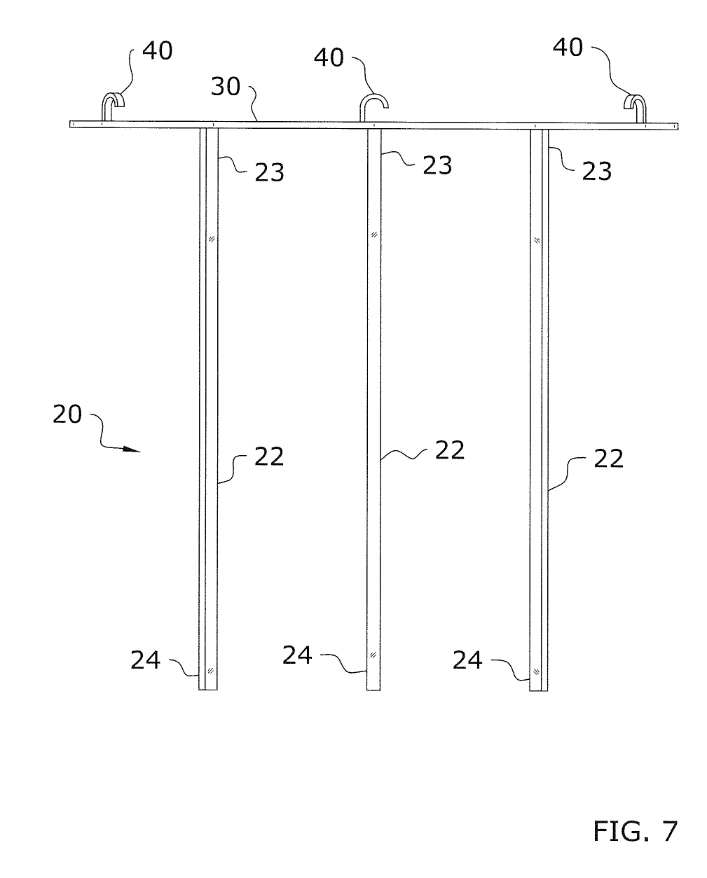

Turning now descriptively to the drawings, in which similar reference characters denote similar elements throughout the several views, FIGS. 1 through 7 illustrate a framework for horizontally supporting plants 10, which comprises a vertical structure 20 having a lower end 24 and an upper end 23, the lower end 24 being inserted within the ground 13 adjacent a plant 14, the upper end 23 adapted to extend above the ground 13, and a horizontal structure 30 that horizontally extends from the upper end 23 of the vertical structure 20.

The horizontal structure 30 generally comprises a plurality of hollow-shaped supports 32, 34, 36 horizontally spaced from each other and connected via connecting supports 38, all of which are generally comprised of a wire structure and all of which are substantially located within a common horizontal plane. The plant 14 generally grows through the central opening 33 of innermost hollow-shaped support 32 and a plurality of fasteners 40 that may extend from the horizontal structure 30 retain an end portion 16 of the plant 14 in a horizontal orientation along the spaced-apart outer supports 34, 36 of the horizontal structure 30.

### B. Vertical Structure

The vertical structure 20 generally comprises a plurality of wire stakes 22 each spaced apart to form a circular, square, or other hollow arrangement. The stakes 22 are preferably comprised of a 9 gauge anchor wire; however alternate materials or diameters may be appreciated. Each of the stakes 22 includes a lower end 24 that is inserted within the ground 13 and an upper end 23 that extends vertically above the ground 13. Generally, 3-15 inch stakes 22 are utilized, however more or less stakes 22 of shorter or lengthier height may alternately be utilized.

Each of the stakes 22 is generally linear in structure and elongated in structure to extend a sufficient height above the ground 13 generally equal in height or similar in height to the lower portion 15 of the plant 14, the lower portion 15 of the plant 14 being the portion not having leaves, fruit, or other blossoming elements. It is appreciated that the height that the upper end 23 extends above the ground 13 may be adjusted according to the height of the plant 14.

The term “ground” may refer to any suitable medium that the plant 14 is within, such as soil, fertilizer mix, etc. within an open space or planter 12, such as a bucket, container, etc. The vertical structure 20 is generally positioned next to the plant 14 so that the plant 14 grows vertically within the hollow interior defined by the stakes 22 or other vertical structure 20. It is appreciated that the lower end 24 may alternately be atop the ground 13, such as rather than inserted within the ground 13 or may be supported in various manners all which preferably keep the vertical structure 20 in a vertical orientation or generally perpendicular to the ground 13.

### C. Horizontal Structure

The horizontal structure 30 generally comprises a plurality of horizontally oriented supports 32, 34, 36 perpendicularly extending from the upper end 23 of the stakes 22. Each of the supports 32, 34, 36 are preferably comprised of a wire structure, such as 9 gauge anchor wire. The horizontal structure 30 generally includes the hollow-shaped first support 32 having a first diameter (such as 8.5 inches), the hollow-shaped second support 34 having a second diameter (such as 12.5 inches) larger than the first diameter, and the hollow-shaped third support 36 having a third diameter (such as 16 inches) larger than the second diameter.

The supports 32, 34, 36 being hollow-shaped via the central opening 33 of the first support 32, the first separation space 35 defined between the second support 34 and first support 32, and the second separation space 37 defined between the third support 36 and the second support 34. The second support 34 is thus generally spaced horizontally outwardly from the first support 32 via the separation space 35 and the third support 36 is positioned horizontally outwardly from the second support 34 via the separation space 37. It is appreciated that more or less hollow-shaped supports 32, 34, 36 may be utilized, such as more hollow-shaped supports positioned closer to each other and/or more hollow-shaped supports extending further horizontally outward to accommodate for larger and/or taller plants 14.

The hollow-shaped supports 32, 34, 36 may be shaped in various manner, such as all being circular rings, all being rectangular or square ring-shaped, or some being rectangular or square and some being circular (e.g. first and second supports 32, 34 being circular, third support 36 being rectangular), as well as various other shapes. Each of the supports 32, 34, 36 are hollow-shaped to allow the end portion 16 of the plant 14 or portion having the leaves, fruit, or other blossoming elements to be intertwined thereupon to retain the end portion 16 of the plant 14 in the horizontal orientation, the innermost support especially being hollow-shaped to align with the center hollow-part of the arrangement of the stakes 22 of the vertical structure 20 for the plant 14 to grow through.

At least one and preferably a plurality of connecting supports 38 (such as at each corner or 90 degree separation) extend from the innermost support 32 to the outermost support 36 to connect the supports 32, 34, 36 together, wherein the supports 32, 34, 36 are not directly connected to each other, wherein the supports 32, 34, 36 are spaced horizontally from each other, such as by being equidistantly spaced from each other. The connecting supports 38 are similarly preferably comprised of a 9 gauge anchor wire and may connect the supports 32, 34, 36 in various manners, such as by being weldebly attached. The inner end of the connecting supports 38 terminates at the innermost support 32 and the outer end of the connecting supports 38 terminates at the outermost support 36.

The horizontal structure 30 including each of the hollow-shaped supports 32, 34, 36 and preferably the connecting supports 38 are located within a common horizontal plane, such as perpendicular to the vertical plane that the vertical structure 20 extends within. The common horizontal plane extends laterally outward from the stakes 22 to accommodate the plant 14 as the plant 14 grows, wherein as the plant 14 grows the outermost ends are and portions therebetween are secured to the horizontal structure 30. The horizontal structure 30 is also preferably in the same common horizontal plane as the upper end 23 of the vertical structure 20; however it is appreciated that the horizontal structure 30 may rest atop the vertical structure 20, thus being slightly above the upper end 23 of the vertical structure 20.

### D. Fasteners

The fasteners 40 may be used and generally extend from the horizontal structure 30 at various locations spaced horizontally outwards from the innermost support. The fasteners 40 may be located upon the hollow-shaped supports 32, 34, 36 and/or the connecting supports 38. The fasteners 40 are for retaining the end portion 16 of the plant 14 to the horizontal structure 30 to ensure that the plant 14 grows horizontally outwards and ensures that the end portion 16 of the plant 14 including the leaves, fruit, or other blossoming elements receive adequate light and water and are not shaded by other portions of the plant 14.

The fasteners 40 may be comprised of various structures, such as string, hooks, or other tie mechanisms. Alternately, or in addition to the fasteners 40, the plant 14 may be intertwined through the hollow-shaped supports 32, 34, 36 from an innermost support 32 to the outermost support 36.

### E. Operation of Preferred Embodiment

In use, framework 10 is positioned next to the growing plant 14 with the lower end 24 of the vertical structure 20 being inserted within the ground to stabilize the framework 10 in an upright orientation. The plant 14 is directed centrally between the stakes 22 so the plant 14 is aligned with the central opening 33 of the first support 32.

As the end portion 16 of the plant 14 grows vertically upwards through the central opening 33 of the hollow-shaped first support 32 and above the first support 32 the end portions 16 of the plant 14 are secured to the horizontal structure 30, either via the fasteners 40 or being looped through the spaced-apart hollow-supports 34, 36. As the plant 14 continues to grow the end portion 16 is subsequently retained by the next hollow-shaped support, such as the third support 36, to retain the end portion 16 of the plant 14 in a substantial horizontal orientation to ensure that the plant 14 receives sunlight and other nutrients evenly throughout each stem or branch of the plant 14.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A framework for horizontally supporting plants, comprising:
at least one vertical stake having a lower end and an upper end;
said lower end adapted to be inserted into the ground adjacent a plant, said upper end adapted to extend above the ground;
an inner support extending from said upper end of said at least one vertical stake, said inner support being hollow-shaped; and
at least one outer support horizontally spaced from said inner support, said at least one outer support and said inner support are positioned within a common horizontal plane for retaining an end portion of a plant in a horizontal orientation.

2. The framework of claim 1, wherein said at least one outer support includes a plurality of outer supports each located within said common horizontal plane.

3. The framework of claim 2, wherein each of said outer supports are horizontally apart from each other.

4. The framework of claim 1, including at least one connecting support for connecting said inner support to said plurality of outer supports.

5. The framework of claim 1, wherein said connecting support is located within said common horizontal plane.

6. The framework of claim 1, wherein said at least one vertical stake is comprised of a plurality of vertical stakes.

7. The framework of claim 1, wherein said upper end of said vertical stake is positioned substantially within said common horizontal plane.

8. The framework of claim 1, wherein said inner support is comprised of a circular ring shape.

9. The framework of claim 1, wherein said at least one outer support forms a hollow-shape.

10. The framework of claim 9, wherein said at least one outer support is comprised of a circular ring shape.

11. The framework of claim 9, wherein said at least one outer support is comprised of a rectangular or square shape.

12. The framework of claim 1, including at least one fastener extending from said at least one outer support for securing a plant.

13. A framework for horizontally supporting plants, comprising:
at least one vertical stake having a lower end and an upper end;
said lower end adapted to be inserted into the ground adjacent a plant, said upper end adapted to extend above the ground;
a first horizontal support extending from said upper end of said at least one vertical stake, said first support being of a hollow-shape;
a second horizontal support horizontally and outwardly spaced from said first horizontal support, said second support being of a hollow-shape;
a third horizontal support horizontally and outwardly spaced from said second horizontal support, said third support being of a hollow-shape;
wherein said first horizontal support, said second horizontal support, and third horizontal support are each entirely positioned within a common horizontal plane; and
at least one connecting support for interconnecting said first horizontal support, said second horizontal support, and said third horizontal support.

14. The framework of claim 13, wherein said first horizontal support, said second horizontal support, and third horizontal support are each comprised of a circular ring shape.

15. The framework of claim 13, wherein said first horizontal support, said second horizontal support, and third horizontal support are each comprised of a rectangular or square shape.

16. The framework of claim 13, wherein said at least one connecting support is located within said common horizontal plane.

17. The framework of claim 13, wherein said second horizontal support has a larger diameter than said first horizontal support and wherein said third horizontal support has a larger diameter than said second horizontal support.

18. The framework of claim 13, wherein each of said horizontal supports are comprised of a wire structure.

19. The framework of claim 13, wherein said first horizontal support, said second horizontal support, and third horizontal support concentric.

20. A framework for horizontally supporting plants, comprising:
a vertical structure having a lower end and an upper end;
said lower end adapted to be inserted into the ground adjacent a plant, said upper end adapted to extend above the ground;
a horizontal structure having a central opening, said horizontal structure extends from said upper end of said vertical structure in a horizontal manner; and
a plurality of fasteners extending from and horizontally spaced along said horizontal structure for retaining an end portion of a plant thereto that extends through said central opening.
